(19) United States
(12) Patent Application Publication
(10) Pub. No.: US 2008/0185759 A1
(43) Pub. Date: Aug. 7, 2008

(54) Method for making bricks

(76) Inventor: Chia Hsin Lee, Caotun Township (TW)

Correspondence Address: CHARLES E. BAXLEY, ESQ., 90 JOHN STREET, THIRD FLOOR, NEW YORK, NY, 10038, US

(21) Appl. No.: 11/704,392

(22) Filed: Feb. 7, 2007

(51) Int. Cl. C04B 35/64

(52) U.S. Cl. 264/666

(57) ABSTRACT

A method for making bricks includes a step mixing ceramic earth, quartz sands and Styrofoam as a base and putting the base in a first mold; a step of coating a top layer of ceramic earth on a top of the base; a step of molding surface patterns on the top layer of the base by a second mold, a step of kilning the base in step of making surface patterns for six hours at 1100 degrees Celsius to form a semi-product, a step of coating a layer of glaze on surfaces of the semi-product, and a step of kilning the semi-product for at least one hour at 900 to 1000 degrees Celsius. The base and the top layer are crystallized so as to have desired surface patterns and the Styrofoam is vaporized so as to form holes in the brick.

### FIELD OF THE INVENTION

The present invention relates to a method for making bricks with desired exterior patterns and the bricks are light in weight.

### BACKGROUND OF THE INVENTION

A conventional bricks for exterior use for buildings generally are rocks such as marbles which has natural colors and fixed density. However, to obtain bricks of natural rocks require high cost and complicated processes. The rocks have to be cut, ground, polished and long distance of transportation. The rocks are cut into proper sizes so as to be used as bricks. The bricks are heavy and some are easily broken. When attaching the bricks to the exterior surface of buildings, cement or adherent are necessary to fix the bricks on the building and metal support members are used to further fix the heavy bricks. In other words, a high cost is involved when using the bricks made by natural rocks.

The present invention intends to provide a method for making bricks which are light in weight and the surface patterns can be easily formed by proper molds.

### SUMMARY OF THE INVENTION

The present invention relates to a method for making bricks and the method comprises the following steps:

a step of making base: mixing ceramic earth, quartz sands and Styrofoam as a base and putting the base in a first mold;

a step of making surface layer: coating a top layer of ceramic earth on a top of the base;

a step of making surface patterns: molding surface patterns on the top layer of the base by a second mold;

a step of kilning: kilning the base in step of making surface patterns for six hours at 1100 degrees Celsius to be a semi-product;

a step of coating glaze: coating a layer of glaze on surfaces of the semi-product, and

a step of kilning: kilning the semi-product for at least one hour at 900 to 1000 degrees Celsius.

The primary object of the present invention is to provide a method for making bricks which have desired surface patterns.

Another object of the present invention is to provide a method for making bricks which are formed by kilning at 1100 degrees Celsius and the Styrofoam is vaporized during kilning so as to form holes in the bricks thereby obtaining the bricks light in weight.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows steps of the method for making bricks of the present invention.

### DETAILED DESCRIPTION OF THE PREFERRED EMBODIMENT

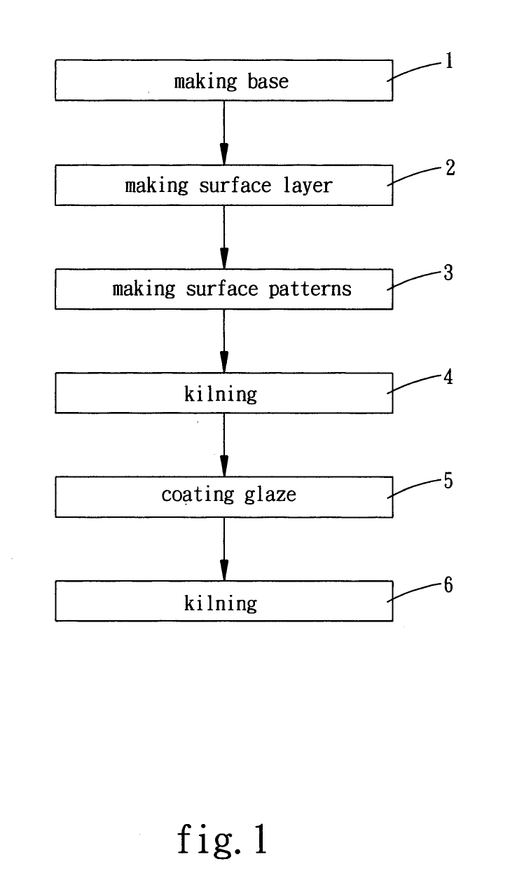

Referring to FIG. 1, the method for making bricks of the present invention comprises the following steps:

a step of making base 1: mixing ceramic earth, quartz sands and Styrofoam as a base and putting the base in a first mold;

a step of making surface layer 2: coating a top layer of ceramic earth on a top of the base;

a step of making surface patterns 3: molding surface patterns on the top layer of the base by a second mold;

a step of kilning 4: kilning the base in step of making surface patterns for six hours at 1100 degrees Celsius to form a semi-product;

a step of coating glaze: coating a layer of glaze on surfaces of the semi-product, and

a step of kilning: kilning the semi-product for at least one hour at 900 to 1000 degrees Celsius.

The contents in the base are crystallized during the step of kilning so as to form the brick and the surface patterns. The layer of glaze provides the bricks made by the method of the present invention to have an attractive appearance. The Styrofoam is vaporized during kilning and forms a plurality of tiny holes in the bricks. The tiny holes make the bricks made by the method of the present invention to be light in weight so that the bricks can be easily attached to exterior surface of building without need of metal support members.

The method provides an easy way to produce the bricks used on exterior surfaces of buildings and the bricks have desired surface patterns. The bricks made by the method of the present invention are light and easily to be attached on exterior surface of buildings.

While we have shown and described the embodiment in accordance with the present invention, it should be clear to those skilled in the art that further embodiments may be made without departing from the scope of the present invention.

What is claimed is:

1. A method for making bricks comprising:
a step of making base: mixing ceramic earth, quartz sands and Styrofoam as a base and putting the base in a first mold;
a step of making surface layer: coating a top layer of ceramic earth on a top of the base;
a step of making surface patterns: molding surface patterns on the top layer of the base by a second mold;
a step of kilning: kilning the base in step of making surface patterns for six hours at 1100 degrees Celsius to form a semi-product;
a step of coating glaze: coating a layer of glaze on surfaces of the semi-product, and
a step of kilning: kilning the semi-product for at least one hour at 900 to 1000 degrees Celsius.
